(19) United States
(12) Patent Application Publication
(10) Pub. No.: US 2009/0282328 A1
(43) Pub. Date: Nov. 12, 2009

(54) System and method for generic configuration for web interfaces

(75) Inventors: Ronald D. Olsen, Lake View, NY (US); Brian Kamrowski, Amherst, NY (US)

Correspondence Address: WEINGARTEN, SCHURGIN, GAGNEBIN & LEBOVICI LLP, TEN POST OFFICE SQUARE, BOSTON, MA, 02109, US

(73) Assignee: Dialogic Corporation

(21) Appl. No.: 12/151,711

(22) Filed: May 8, 2008

(51) Int. Cl. G06F 3/14

(52) U.S. Cl. 715/234

(57) ABSTRACT

The disclosed system and method provides a generic user interface that can be dynamically configured with configuration data provided by a product coupled to the user interface. The user interface may be hosted on a client system and obtain product configuration data through a server based on requests to and responses from the server. A generic user interface document containing configuration keys can be initially loaded into the user interface. The generic document is scanned to detect the configuration keys, at least some of which configuration keys are used to construct a request for configuration data from the product. The request is processed to return configuration data to the user interface, which can then completely render all the interface components representative of the configuration of the product. The product may be implemented as a gateway, for example, in a telecommunications network.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The presently disclosed system and method relate generally to configuring a user interface, and more particularly to dynamically configuring a generic interface based on user interface configuration data.

A user interface (UI) is often provided for a user to interact with a device or information concerning the device, the information and/or device hereinafter being referred to as a product. The product and the UI typically interact over a connection, which can be in the form of a direct connection or a network connection, for example. A network connection is often used to provide remote access to the product for the user. The UI typically permits the user to access the product to supply input and receive output. Examples of input mechanisms include a keyboard, a mouse, a display, as well as other devices that permit a user to provide input to a machine. Examples of mechanisms that permit the user to receive information include displays, panels with visual indicators, audio and tactile output devices, and any other type of device that permits a user to receive information from a machine. One purpose for a UI is to permit a user to configure the product or receive information about the product, in relation to product maintenance, upgrades, configuration, status or operating parameters, for example.

In computer-based systems, a UI is frequently implemented as a display with a keyboard and a mouse to permit a user to interact with various virtual or physical devices or information. For example, a UI may present various selectable settings that a user can manipulate with input to the UI. The selectable settings presented to the user are typically configured through an application that renders various types of formatted interface components in the UI. The user may manipulate some aspect of the interface component to obtain or provide information, for example in conjunction with a device to which the UI is coupled. In the instances where the UI includes a display device, the application responsible for configuring the UI may render and present interface components such as graphical push buttons, check boxes, radio buttons, text boxes, drop-down boxes, menus, links, and other items that may be familiar to a user for making selections, retrieving data or entering information through the UI.

An example of a conventional UI and product arrangement involves a client-server network topology, where the client system hosts the UI and the server interacts with the product to facilitate information exchanged between the UI and the product. In this arrangement, the UI can be provided as a web browser, for example, that communicates with the server using a hypertext transfer protocol (HTTP) over a TCP/IP (transmission control protocol/internet protocol) controlled communication link. The product may be provided as a device, such as a telecommunication gateway, or a service, such as an application running on a server, for example. Typically, the web browser, either through user interaction or web browser configuration, sends a request to the server to cause a product related web page to be loaded into the web browser from the server. In response, the server provides a requested web page that may contain HTML (hypertext markup language), XML (extensible markup language) and/or scripting code. The HTML, XML and/or scripting code operate in the web browser to render the UI with information related to the product. The rendered UI may also permit a user to interact through the UI to modify or configure the product.

Conventionally, the UI is provided in a static configuration, meaning that the UI is constructed for a specific implementation of the product, and is not adaptable if the configuration of the product changes. In the event that a product configuration is changed, a new UI is conventionally created that corresponds to the new configuration of the product. Conventional U's can therefore be limited in their application, flexibility and usefulness, especially if the product is modified with even slight changes.

For example, an application may be implemented in the client, the product, or a server, to permit information exchange between the UI and the product. The application is generally provided on the basis of a particular configuration of the product, for example by exposing to the UI certain product features, criteria or status existent at the time the application is created. In such a situation, the UI generally reflects a version of the product, and is not adaptable to new product versions, where different settings, criteria or status may be provided in such product versions. In such an instance, a new application is created to accommodate the new version of the product and installed in the UI at the client, the server or the product itself. Recreating an application to match an updated version or configuration of the product can be challenging and time consuming, since in general a completely new application is generated that takes into account all the aspects of the new product version. Even small changes in the configuration of the product can lead to the provisioning of a new application to permit the user to interact with the product through the UI. In addition, distribution of the application can prove difficult, since matching versions of the application with the desired product can be problematic.

Many products today have web-based interfaces that allow a user to query or configure various settings associated with the product. Typically, the product implements some type of web-server, and provides a connection to a computer running a web browser. The product may have several configurable items, with various types of data. For example, one item may consist of a text string, another item may be a “yes/no” choice, and another item may be a selection consisting of multiple choices. These configurable items can be implemented as interface components that are supported by the UI based on the properties and/or attributes of each component to appropriately display the component or respond to input to the component. The application configuring the UI is built with the knowledge of all of the settings for all the interface components associated with the product.

As mentioned above, a conventional UI is static, meaning that the UI is built to interact and operate with a specific configuration of the product. For example, the product may have certain hardware or software features that are accessible through the UI. The HTML, XML and/or scripting code in the web page supplied to the web browser to implement the UI are constructed to provide access for those specific features of the product. If the features of the product for which the HTML, XML and/or scripting code is constructed in the web page should change, such as may frequently occur with installations, upgrades, version changes or any other kind of modification to the product or product features, the application for producing the web page is reconstructed to provide access for the product features as modified. If product features are modified frequently, the additional changes to the HTML, XML and/or scripting code of the web page provided by the server to reflect the product configuration changes can be cumbersome.

The static nature of the UI discussed above can be problematic since the UI is typically reconfigured when configuration items are added or changed in the product, even if the additions or changes are minor. It would be desirable to obtain a UI that supports the varying types of data used by the product without completely reconfiguring the UI.

### BRIEF SUMMARY OF THE INVENTION

The disclosed system and method provides a generic UI framework that can be dynamically configured with information related to a configuration of a product. The UI, upon being dynamically configured, presents the user with interface components that can be interactive to permit the user to configure, query or otherwise interact with the product. The interface components are provided to the UI on a dynamic basis in response to configuration queries addressed to the product. The product provides data to the UI to permit the interface components to be dynamically configured in keeping with the product configuration.

In one aspect, the disclosed system and method provides a UI in a web browser that can be rendered using a hypertext markup language (HTML) and a scripting language, such as JavaScript®. The product is implemented as a gateway with an embedded server coupled to the UI. An HTML document is configured to be a generic framework with a minimal configuration or knowledge about the product configuration. Configuration keys within the HTML code are detected by executing scanning logic, such as a script, to prompt requests for configuration data to configure the interface components in the UI. The requests are directed to the embedded server in the gateway, which responds with configuration data used by the script in rendering the interface components in the UI. The rendered interface components may include, for example, displays that are updated with polling requests to the server to receive updated data from the gateway.

### BRIEF DESCRIPTION OF THE SEVERAL VIEWS OF THE DRAWINGS

The disclosed system and method are described in greater detail below, with reference to the accompanying drawings, in which:

FIG. 1 is a diagram illustrating the configuration of a generic user interface with configuration data from a product;

FIG. 2 is a diagram illustrating an exemplary embodiment of the configuration of a generic user interface with configuration data;

FIG. 3 is a flow chart illustrating a process for configuring a generic user interface with configuration data; and

FIG. 4 is an illustration of an exemplary embodiment of a configured interface component in accordance with the disclosed system and method.

### DETAILED DESCRIPTION OF THE INVENTION

An example of a product for which the conventional arrangement described above may apply is in the case of a gateway that implements an embedded web server. A gateway is a telecommunications device used to provide an interface between telecommunication networks that may use different protocols. As discussed above for a product in general, the gateway may be installed, configured, upgraded or otherwise modified to provide new or additional features or functionality, for example. The gateway with the embedded web server can be implemented as a media gateway, such as the Dialogic 1000 Media Gateway series or the Dialogic 2000 Media Gateway series, which are commercially available from Dialogic Corporation of Montreal, Quebec, Canada.

As configuration changes are made to the gateway, the web pages provided by the embedded server are conventionally modified to reflect the modifications to the gateway, so that the UI provided through the received web page accurately reflects the current configuration of the gateway.

The disclosed system and method provide for a UI that is initialized with a generic configuration, and is subsequently dynamically configured with configuration data supplied by a product to which the UI is coupled. In one exemplary embodiment, the UI is dynamically configured with the configuration data and built before being exposed to the user. Building the user interface prior to display can eliminate undesirable latency effects. The dynamic configuration of the UI permits the UI to be rendered based on up to date information, configuration or status, for example, supplied by the product. Accordingly, if the product is updated with a new installation, such as a new version of software or hardware, for example, a new UI need not be completely constructed and distributed for use with the modified configuration of the product. Instead, the dynamically configured UI is presented to the user to interact with the product, without having to be recreated and built with the configuration items, item formatting or content that is specific to the product as updated or modified.

The UI may be implemented as any type of interface, including those interfaces that can be implemented on widely available or popular platforms, such as with a windowed application on a mini or micro computer. For example, the UI may be implemented on a PC as a set of windowed web pages. The product may be any type of device that can be connected to the UI to permit information exchange between the UI and the product. Examples of products include embedded devices, such as may be implemented with task-specific hardware and software.

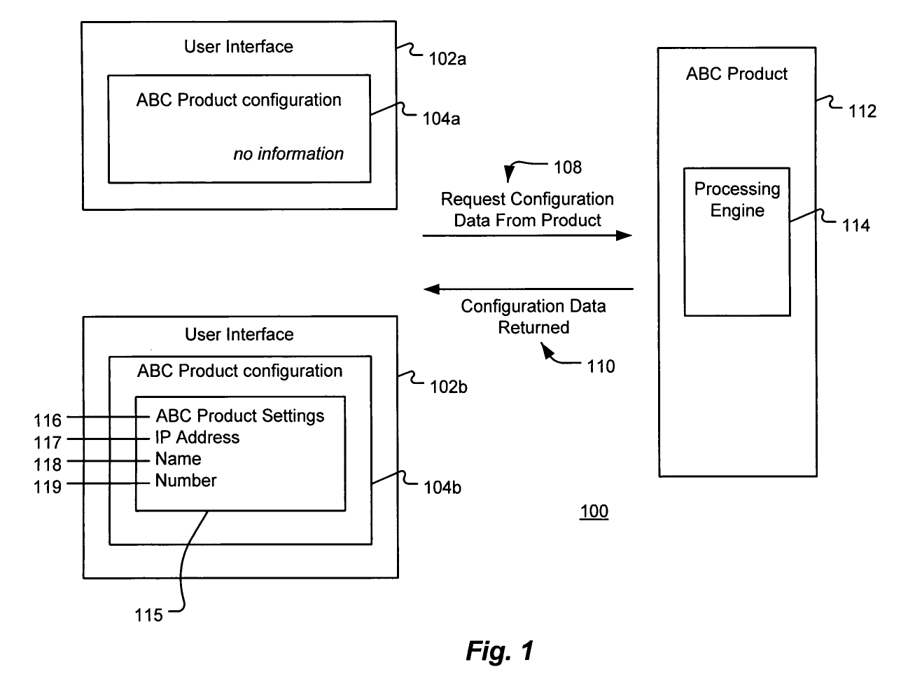

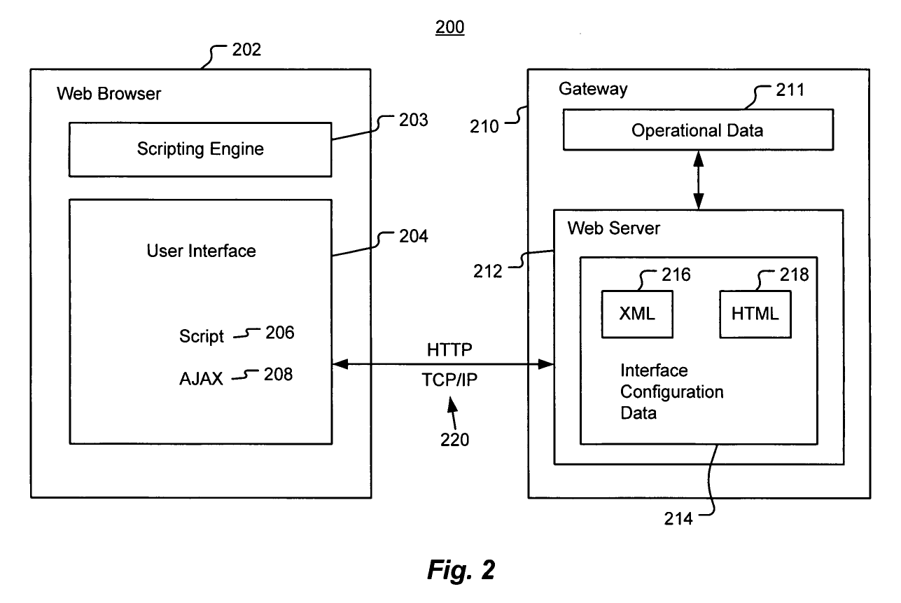

Referring now to FIGS. 1 and 2, a generalized diagram of a system 100 for a dynamically configured UI is illustrated. System 100 provides a user interface (UI) 102a,b that permits a user to interact with a product designated, purely for the sake of generic reference, as “ABC product” 112. In this generalized exemplary embodiment, UI 102a,b provides information in relation to ABC product 112 in a box 104a,b. UI 102a represents a generic user interface, whereas UI 102b represents a fully configured user interface. Initially, box 104a contains no information specific to ABC product 112, other than a title or other generic information, such as a simplistic menu, for example. Box 104a may be initialized in a generic state as taken from a storage location (not shown) in UI 102a or from ABC product 112, for example, by having ABC product 112 respond to a request from UI 102a to load generic information into box 104a.

The generic information loaded in box 104a includes various configuration keys that act as place holders for obtaining configuration data for implementing interface components within box 104a. The configuration keys are used to prompt a request for configuration data to configure box 104a. In an exemplary embodiment, the configuration keys are grouped into different categories related to different tasks. For example, configuration keys may be grouped into categories for purposes related to product maintenance, configuration, status and/or upgrade. A mechanism that provides scanning logic, such as scripting engine 203 (FIG. 2), which is used as an interpreter for web page scripts, is implemented within UI 102a and employed to scan a content of box 104a for the configuration keys, and produce requests for configuration data for configuring interface components. Any type of scanning logic, such as a script, can be used to conduct the scan. The detected configuration keys are used to identify a request for one or more configuration items—that is, each configuration key can be used to establish a request for configuration data for a single interface component, or a request for configuration data for a group of interface components. UI 102a builds a request for configuration data for interface components based on detection of the configuration keys. The request can be packaged into a single file, for example, and submitted to the source of configuration data for ABC product 112, such as, for example, a configuration data source provided in ABC product 112. In such an exemplary embodiment, UI 102a builds a configuration request using a configuration key file that contains configuration requests based on the configuration keys. UI 102a provides request 108 to ABC product 112 to request the identified configuration data based on the detected configuration keys.

ABC product 112 processes request 108 to develop the configuration data to be returned to UI 102b. ABC product 112 has a processing engine 114 that examines the configuration keys provided in request 108, and produces a response file with configuration data provided in accordance with the configuration keys. The processing of configuration keys in ABC product 112 provides detail and context for the interface components to be rendered, as identified by the configuration keys. For example a configuration key may identify an interface component, or a group of interface components. When processed by ABC product 112, configuration data is provided for each interface component identified in each configuration key. The configuration data provides the relevant information, used by UI 102b, to completely render each interface component identified with the configuration keys.

When ABC product 112 completes processing of the configuration keys to form a response file, the response file is returned to UI 102b through return path 110. UI 102b accepts the return configuration file, and uses the configuration data contained therein to render box 104b. In the exemplary embodiment shown in system 100 of FIG. 1, the return configuration data includes information for rendering a box 115 as an interface component with a number of entries. The entries in box 115 include an interface component 116, which reads “ABC Product Settings,” an interface component 117, which provides an IP address, an interface component 118, which provides a name and an interface component 119, which provides a number. The configuration data for each of interface components 115-119 is provided through a content of the returned configuration file from ABC product 112. For example, the configuration data may include categorized parameters for rendering interface components 115-119. Such categorized parameters in the configuration data may include, for example, a label, a type of configuration data, such as text or numeric, a current value, or any other type of parameter that may be used to contribute to rendering interface components 115-119.

UI 102b can be provided in the form of a background type task, so that configuration data may be obtained through return path 110, and box 104b can be rendered completely, prior to being displayed in a UI. With such an arrangement, a user sees the completely rendered UI all at once, rather than seeing a UI being constructed in portions. The background constructed UI may be more desirable for a user, since otherwise observable latency in rendering the UI is prevented.

Referring to FIG. 2, an example of a dynamically configured UI is illustrated with respect to a client-server type system 200. System 200 includes a web browser 202 that interacts with a web server 212 through a communication link 220 that operates using HTTP and TCP/IP. In the exemplary embodiment of system 200, web server 212 is implemented as an embedded web server as part of a gateway 210. Web server 212 provides interface configuration data 214 to configure a UI 204 in accordance with the disclosed system and method. Configuration data 214 can take the form of XML data 216 or HTML data 218. Web server 212 can also access operational data 211, which represents configuration data or operating information that is available for gateway 210.

UI 204 may be rendered in part using a scripting engine 203, which can be a JavaScript interpreter, for example. Scripting engine 203 executes scripts that may form part of an HTML page to obtain configuration data for rendering UI 204, for example. UI 204 can also take advantage of AJAX type requests, which permit asynchronous requests to be submitted to web server 212 over link 220 to obtain dynamic data that can be displayed in UI 204 without reloading or re-rendering UI 204.

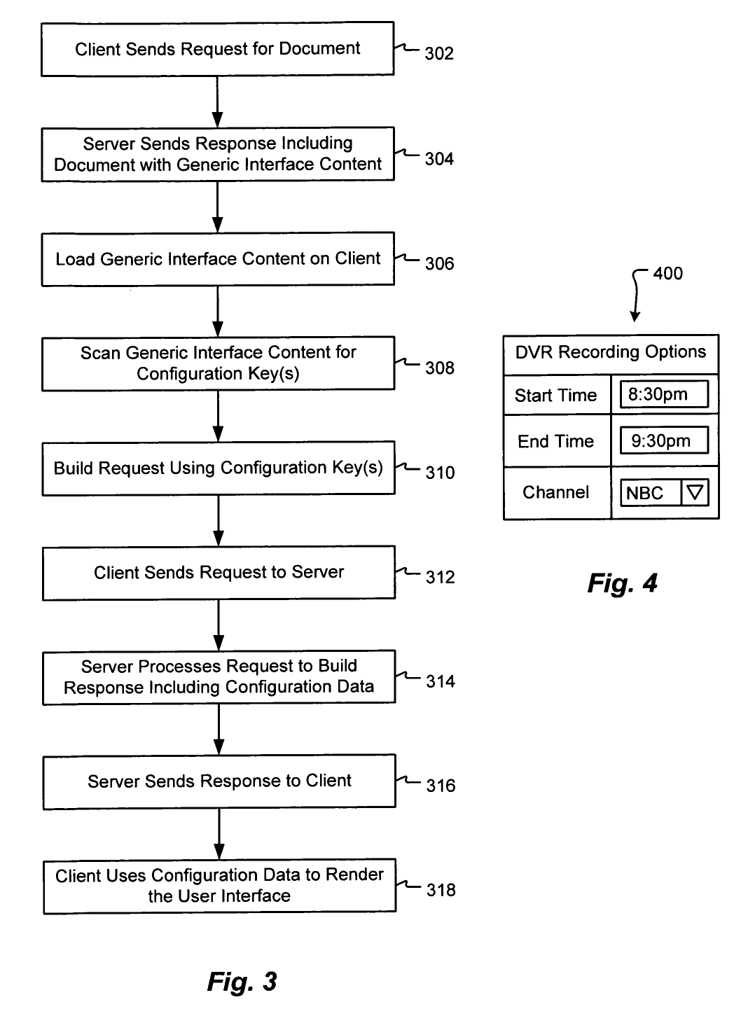

Referring also now to FIG. 3, an exemplary embodiment of the disclosed system and method is illustrated that operates to dynamically configure UI 204. In an initial operation to realize the dynamic configuration of UI 204, a client that hosts web browser 202 sends a request for a document to load UI 204, illustrated in block 302 of FIG. 3. The requested document may be, for example, an HTML-coded document or web page. Block 304 illustrates web server 212 providing a response that includes the requested document in an initial state—that is, having a generic interface content. The document is provided to web browser 202 over link 220, and loaded into UI 204, as illustrated in block 306 of FIG. 3. Upon being loaded in UI 204, the document is scanned using scripts that can execute when the document is loaded into UI 204. The scripts execute to scan the document in the initial state, that is, having a generic interface content, to detect configuration keys, as illustrated in block 308. Once the scripts have scanned the document and detected configuration keys, UI 204 causes a request to be built using the detected configuration keys, as illustrated in block 310. The request may be built to include a file that has a content that includes formatted data related to the detected configuration keys. For example, the file may include XML code identifying the desired configuration data.

In block 312, the request compiled by UI 204 is provided to web server 212 over communication link 220. Web server 212 processes the request to construct a response that includes configuration data as illustrated in block 314. For example, the response includes configuration data in a format in accordance with XML 216 or HTML 218. The configuration data 214 provided by web server 212 represents a complete set of information for web browser 202 to render UI 204. Each configuration item or group of items provided in the request sent to web server 212 is analyzed and expanded with configuration data content to construct the response provided to web browser 202. When the construction of the response is complete, web server 212 sends a response to web browser 202 over communication link 220, as illustrated in block 316. The response received by web browser 202 is processed to render the interface components in UI 204 with the configuration data provided in the response, as illustrated in block 318.

According to an exemplary embodiment, web browser 202 may cause UI 204 to be rendered in a background mode using the configuration data returned form web server 212. After being completely rendered in background mode, UI 204 can be presented to the user. By rendering UI 204 in a background mode, where UI 204 is not visible to a user, a completed UI 204 is provided to the user, thereby eliminating latency effects that may be visible while UI 204 is being rendered.

Once UI 204 is rendered and available to the user, scripts 206 and AJAX 208 can be used to update UI 204, and the configured components of UI 204, by submitting asynchronous requests to web server 212 over communication link 220. The asynchronous requests received by web server 212 prompt data queries to operational data 211 to obtain updated parameter values, which are returned to UI 204 to update the corresponding interface components. With this configuration, UI 204 is dynamically rendered, and updated in apparent real time, or provides an apparent live connection to gateway 210 and the parameter values and information of gateway 210.

An example of a system and method in accordance with the present disclosure follows. In this example, a client-server environment is implemented, with the client hosting the UI, which is dynamically configured in accordance with the disclosed system and method.

### EXAMPLE

In this example, a UI has been initialized with a generic configuration document, such as may be obtained by a web browser hosted by a client upon submission of a request to a server to obtain an initial browser document. The generic configuration of the browser document contains minimal information reflecting minimal knowledge of data available from the server. The generic configuration of the browser document includes configuration keys that help to determine the information that should be requested from the server. The example illustrates a process for dynamically configuring the UI with the operations of (1) scanning the document; (2) requesting data; (3) processing and returning data; and (4) rendering the UI.

Scanning the Document

When the generic configuration document is loaded in the UI, a script is executed by the UI to scan the generic configuration document for configuration keys. The configuration keys contribute to determining the configuration information that should be requested and returned from the server. In this exemplary embodiment, the generic configuration document is an HTML document, which is scanned by the script for certain predefined key words within the HTML element attributes. The HTML attributes can be unique to identify the configuration keys uniquely. Alternatively, or in addition, the configuration keys may each be implemented as an element ID with a keyword prefix. The keyword prefix indicates a type of request that is to be submitted with the respective element ID. When the script scanning the HTML document detects one of the keywords in the prefix, for example, the remainder of the element ID is identified as the configuration key. The following HTML code illustrates the exemplary embodiment of providing configuration keys in an element ID.

```
<body>
  <table>
    <thead><tr><th>Some Table Heading</th></tr><thead>
    <tbody id=’group:IP-Settings’>
    </tbody>
  </table>
  <div>Start Time is </div> <div id=’item:start-time’>&nbsp;</div>
  <div>End Time is </div> <div id=’item:end-time’>&nbsp;</div>
</body>
```

In the above example, a script scanning the HTML code detects three elements with keyword prefixes that match the particular keywords of “group” or “item.” The keywords together with the configuration keys are used to build a request file for submission to the server. Once all the configuration keys are identified by the script scan, the request file is completed and a request can be dispatched to the server.

Requesting Data

The request file is submitted from the UI to the server to request configuration data from the server. The content of the request file can provide for various types of requests, such as, for example, requesting all available configuration data, a portion of the available configuration data, or a specific item of configuration data. The different types of requests can be implemented according to a similar mechanism. The following example XML files illustrate several of the different types of requests that can be provided in the request file submitted to the server.

1. Request all configuration data from the server:

<?xml version=“1.0” encoding=“iso-8859-1”?>
<config-read>
<all />
</config-read >

In the above sample XML file, the request is submitted to obtain all available configuration data.

2. Request for two groups of configuration data:

```
<?xml version=“1.0” encoding=“iso-8859-1”?>
<config-read>
  <group>IP-Settings</group>
  <group>Recording-Options</group>
</config-read >
```

In this sample XML file, the request is made for all interface components and configuration data in the groups “IP-Settings” and “Recording-Options.”

3. Request for individual interface components:

```
<?xml version=“1.0” encoding=“iso-8859-1”?>
<config-read>
  <item>address</item>
  <item>subnet</item>
  <item>start-time</item>
  <item>end-time</item>
</config-read >
```

In this sample XML file, configuration data for the explicitly defined items, which can be interface components, are requested.

4. Request for a combination of a group and individual interface components:

```
<?xml version=“1.0” encoding=“iso-8859-1”?>
<config-read>
  <group>IP-Settings</group>
  <item>start-time</item>
  <item>end-time</item>
</config-read >
```

In this sample XML file, configuration data for all interface components in the group “IP-Settings” are requested, and configuration data for the specific items “start-time” and “end-time” is requested. This example request as a combination of request types reflects a request file resulting from scanning the example HTML code provided above.

Once an XML file is built based on the detected configuration keys, as illustrated in the above examples, an AJAX request can be sent to the server. The AJAX request is an asynchronous request submitted to the server using XML formatted data. The server receives the AJAX request for processing to produce the configuration data for the requested interface components.

Processing and Returning Data

The server has all of the information associated with the configuration of a component of the UI, or a group of components. The server sends every aspect of a configurable component to the UI, so that the component can be completely rendered with the returned information. Examples of information returned in relation to a given interface component include a data type, labels, possible values, a current value, as well as other types of attributes that can contribute to the configuration of a given component.

In accordance with an exemplary embodiment, a server produces an XML format file in response to the request from the UI. The server processes the request from the UI and builds a response XML file dynamically with the configuration data indicated by the processed configuration keys. The following attributes are given as examples of configuration data that can be returned for an interface component.

Label—The label the server uses for this interface component. The label may be displayed in the UI.

Current Value—The currently configured value for this interface component.

Group—The group name that this interface component belongs to. This may equate to a table in the UI.

Restart Required—Tells the UI that a restart may be desired if the user changes the setting associated with this interface component.

Help—Help text associated with the interface component.

Error—The current configuration has an error condition.

Type—The type of data used to store this interface component. A number of different data types may be used, as supported by the UI upon being rendered. Examples of some of the possible data types are as follows.

Text—Simple text input

Number—Numeric values

Selection—A selection from a list of possible choices

Boolean—Enable or Disable (Yes/No)

Some data types, such as the “Selection” data type listed above, may call for a list of items, such as in the exemplary case of a list of selection options, or a drop-down selection box. With such data types, additional data items may be provided as listed below.

Choice—One of the options to be provided in a drop-down selection box.

Disables—Gives the UI a list of individual interface components or a list of groups of interface components received from the XML file that are to be disabled if a given interface component is set to a given value. Disabling various interface components often is desirable in the case of selection choice alternatives. For example, some options in an interface component may be unavailable if a particular setting for the interface component is chosen.

Once the server processes the request file and constructs a response file containing the configuration data, the response file is returned to the UI for rendering of the interface components. The following is a sample XML file that the server may send to the UI in response to a request for the group “Recording-Options.”

```
<?xml version=“1.0” encoding=“iso-8859-1”?>
<config-return>
  <group>
    <tagName>Recording-Options</tagName>
    <label>DVR Recording Options</label>
  </group>
  <items>
  <start-time>
    <group>Recording-Options</group>
    <label>Start Time</label>
    <type>text</type>
    <value>8:30pm</value>
  </start-time>
  <end-time>
    <group>Recording-Options</group>
    <label>End Time</label>
    <type>text</type>
    <value>9:30pm</value>
  </end-time>
  <channel>
    <group>Recording-Options</group>
    <label>Channel</label>
    <type>selection</type>
    <choice>ABC</choice>
    <choice>CBS</choice>
    <choice>NBC</choice>
    <choice>Fox</choice>
    <value>NBC</value>
  </channel>
  </items>
</config-return>
```

The above content of the response file returned from the server informs the UI that there are three items that are to be displayed that permit user modification. The three items, “Start Time,” “End Time” and “Channel,” are listed with all the information that the UI needs to render the associated interface components. The rendered UI containing these three interface components matches the expected configuration of the server. The user can manipulate the interface components, such as by selecting an item in a drop-down box, to prompt a command to the server to cause the server to modify the configuration of the server. In such an instance, the manipulation of the interface components and the resulting command to the server matches the configuration of the server, so that an appropriate modification to the proper data can be achieved.

Rendering the UI

Once the response file is returned to the UI, all the appropriate data to render the UI is available. In accordance with an exemplary embodiment, the UI is implemented in a web page and a script library, such as may be implemented with JavaScript, dynamically creates interface elements on a display. An example of steps executed by the script library to render the web page follows.

1. Read the XML file returned from the server and create a table for each of the returned groups.

2. Set the table title text with the label for the group found in the XML file.

3. Scan the items (within the <items> indentation in the above example) in the XML file. For each item, add a row to the table created in step 1 to which group the item is assigned. Assign the row two columns, one for the label and one for the editable control.

4. For each item, extract the label from the XML file and set the label column text.

5. For each item, extract the type from the XML file. Dynamically create a type of control that matches the extracted type. For example, if the extracted type is “text”, add an editable text box to the second column in the row. If the extracted type is “selection”, add a selection box.

6. In the case where the type is “selection”, add the selection options from the data received (the information within the <choice> tags) from the XML file.

7. Fill in the value from the XML file into the editable control built in steps 5 and 6.

Given the XML file returned from the server in the above example, rendering the UI produces a table such as is illustrated in FIG. 4.

More complex functions for rendering the UI can be implemented using the script code. For example, editable controls, such as those discussed above and illustrated in FIG. 4, can be disabled through the use of a “disable” tag provided in the XML file returned from the server. Disabled controls can trigger a message such as “restart required” if the user changes an interface component with the “restart” tag set. The functionality provided for rendering the UI is as flexible as the type of data sent from the server, and the support provided by the script library.

As the user modifies interface components in the UI, information is further exchanged with the server, for example by using an AJAX request. A number of other techniques and methods are available for exchanging data between the user and the server, as will be apparent to those skilled in the art.

The operations herein described are purely exemplary and imply no particular order. Further, the operations can be used in any sequence when appropriate and can be partially used. With the above embodiments in mind, it should be understood that the disclosed system and method can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed system and method can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion. The foregoing description has been directed to particular embodiments of this invention. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the invention.

What is claimed is:

1. A method for dynamically configuring a user interface for use with a product, the method comprising:
loading a generic document having configuration keys into the user interface;
scanning the generic document to detect at least some configuration keys;
composing a request having a content related to the detected configuration keys for submission to the product to obtain configuration data from the product;
receiving a response having configuration data corresponding to the detected configuration keys from the product; and
rendering the user interface with the configuration data.

2. The method according to claim 1, further comprising:
constructing the generic document as an HTML document.

3. The method according to claim 1, further comprising:
scanning the generic document using scanning logic.

4. The method according to claim 3, wherein:
using scanning logic further comprises using a script.

5. The method according to claim 1, further comprising:
composing the request as an XML file.

6. The method according to claim 1, further comprising:
receiving XML formatted data as the response having configuration data corresponding to the detected configuration keys for the product.

7. The method according to claim 6, further comprising:
providing one or more data types in the XML formatted data.

8. The method according to claim 6, further comprising:
providing configuration data in the XML formatted data indicating, for an interface component or group of interface components, one or more of a restart being required, disablement, a change to a label or an error condition.

9. The method according to claim 1, further comprising:
rendering the user interface with the configuration data using a script engine.

10. The method according to claim 1, further comprising:
implementing the product as a gateway with an embedded web server.

11. The method according to claim 1, wherein receiving a response further comprises:
receiving all attributes of an interface component used to render the interface component in the user interface.

12. The method according to claim 1, further comprising:
composing an AJAX request for submission to the product to obtain configuration data from a product.

13. The method according to claim 1, further comprising composing:
a request to obtain configuration data for one or more of an interface component or a group of interface components.

14. The method according to claim 1, further comprising:
using the rendered user interface to undertake one or more of a product maintenance, upgrade, configuration, status query or operating parameter query.

15. The method according to claim 1, further comprising:
representing a group of interface components with at least one configuration key.

16. A client-server system implementing the method of claim 1 with the client hosting the user interface and the server interacting with the product.

17. A method for dynamically configuring a user interface with configuration data related to a product and obtained through a server, the method comprising:
loading a generic document having configuration keys into the user interface;
scanning the generic document to detect the configuration keys;
composing a request having a content related to the detected configuration keys for submission to the server to obtain configuration data for the user interface;
processing the request at the server to generate a response having configuration data corresponding to the detected configuration keys;
providing the response to the user interface; and
rendering the user interface with the configuration data.

18. The method according to claim 17, further comprising:
providing configuration data in the response as XML formatted data indicating, for an interface component or group of interface components, one or more of a restart being required, disablement, a change to a label or an error condition.

19. A system for dynamically configuring a user interface for use with a product, comprising:
a processing engine coupled to a memory storage being operable to store program instructions executable by the processing engine to:
load a generic document having configuration keys into the user interface;
scan the generic document to detect the configuration keys;
compose a request having a content related to the detected configuration keys for submission to the product to obtain configuration data from the product;
receive a response having configuration data corresponding to the detected configuration keys from the product; and
render the user interface with the configuration data.

20. The system according to claim 19, further comprising:
the generic document being implemented as an HTML document.

21. The system according to claim 19, further comprising:
a scripting engine accessible by the processing engine to scan the generic document to detect the configuration keys.

22. The system according to claim 19, wherein:
the response further comprises an XML file.

23. The system according to claim 19, wherein:
the product further comprises a gateway with an embedded web server.

24. A system according to claim 19, further comprising:
the configuration data in the response being provided in an XML format and having an indication, for an interface component or group of interface components, for one or more of a restart being required, disablement, a change to a label or an error condition.
